(19) United States
(12) Patent Application Publication
(10) Pub. No.: US 2008/0077963 A1
(43) Pub. Date: Mar. 27, 2008

(54) Method for distributing video clips produced using chroma key processing

(76) Inventor: Navarre Joseph, New York, NY (US)

Correspondence Address: MILBANK, TWEED, HADLEY & MCCLOY LLP, INTERNATIONAL SQUARE BUILDING, 1850 K STRET, N.W., SUITE 1100, WASHINGTON, DC, 20006, US

(21) Appl. No.: 11/524,950

(22) Filed: Sep. 22, 2006

(51) Int. Cl. H04N 7/173; H04N 9/74; H04N 5/222

(52) U.S. Cl. 725/87; 348/722; 348/584

(57) ABSTRACT

A method for distributing a pre-edited, keyed video clip and matte produced using chroma key processing, the method comprising the steps of storing the keyed video clip and matte in an electronic repository and distributing the raw clip, keyed video clip, and matte in a lossless image compression format over the Internet.

### FIELD OF THE INVENTION

The present invention relates to image processing and distribution and more particularly, to a method for distributing high-quality, keyed video clips in a pre-formatted, keyed file format over the Internet.

### BACKGROUND OF THE INVENTION

Chroma key technology is commonly used in the arts of television and film production to replace the background of pictures, videos, and motion pictures. Replacing a background of a picture allows a person filmed in a studio to appear to be in a different environment. For example, in weather broadcasts, a meteorologist is typically filmed standing in front of a blue screen. Using chroma key technology, the background blue screen is replaced with a large weather map. The final picture, including the meteorologist standing in front of a national weather map, is then broadcast for viewing. The meteorologist appears to be standing in front of the map when in fact the meteorologist is being filmed in a studio against a plain blue screen. The film industry also uses chroma key processing to produce visual special effects. For example, a background screen can be replaced with cityscapes, or with any other scene that can be captured or else digitally rendered.

Background replacement using chroma key technology is achieved by first filming a live subject, such as a performer or a presenter, against a monochromatic background screen. Typically, the subject is filmed in front of a blue screen or a green screen. The background screen is then captured separately, using the same lighting as is used to capture the presenter. The background screen captured separately serves as a background reference image. Chroma keying is the process of separating the performer from the background. Using a chroma keying software application, the picture of the performer is separated into its component parts-the live performer and the background screen. During the chroma keying process, background pixels in the original picture are identified by their monochromatic color. Each pixel in the background reference image is identified individually during the keying process. A replacement background is then substituted, pixel by pixel, for the background blue screen. Each background pixel is substituted with a pixel of the new, replacement background.

In order to produce an accurately keyed video clip, each background pixel in the original footage of the presenter, or the raw clip, needs to be precisely identified during the keying process. Therefore, the background reference image should match as closely as possible to the background in the raw clip. Due to the precise nature of the keying process, it is advantageous to use a sophisticated system of cameras under prescribed lighting conditions to capture the raw clip and the background screen. Methods for improving chroma key processing are known in the art. For example, Li, U.S. Pat. No. 6,909,806, IMAGE AND BACKGROUND REPLACEMENT METHOD, discloses a background image replacement system that tolerates variances in studio conditions, such as variances in studio lighting. Also, Mitsui et al., U.S. Pat. No. 6,034,740, KEYING SYSTEM AND COMPOSITE IMAGE PRODUCING METHOD, discloses a means for simplifying real time chroma key background replacement by using pre-recorded background images to replace the background of an image shot in real time.

There are numerous sophisticated software applications that can perform the chroma keying process. If a background screen is accurately shot, a software application can precisely identify the pixels corresponding to the background screen and replace the background pixels with pixels of the new, replacement background. The final product is typically a composite video clip, comprising a picture, video, or film of the presenter against the new, replacement background image.

The composite video clip, however, has limited use for editors or producers wishing to incorporate a video clip into proprietary background scenes. There exists a need to create and distribute professional, keyed video clips produced using chroma key technology where the keyed video clip is distributed separately from a replacement background, thus enabling the end user to substitute his or her own background replacement file and thereby combine the same with the keyed video clip. There also exists a need to distribute the original video footage with the keyed video clip and matte to enable end users to enhance color quality and contrast in their proprietary video clip.

There also exists a need to produce high-quality, stock video footage and distribute the footage in a pre-edited, compressed format. Currently, video clips produced using a chroma keying process are not produced and distributed over the Internet such that end users looking to incorporate stock video footage into their own media can easily search and request for download pre-edited, pre-formatted clips. There is also a need to collect pre-edited, pre-formatted video clips into a central repository in such a way that a user can easily download high-quality keyed video clips in a compressed format over the Internet.

### SUMMARY OF THE INVENTION

The present invention comprises a method for distributing a pre-edited, keyed video clip and matte produced using chroma key processing, the method comprising the steps of storing the keyed video clip and matte in an electronic repository and distributing the raw clip, keyed video clip, and matte as separate files in a lossless image compression format over the Internet.

In one embodiment of the invention, the method further includes the steps of capturing a raw clip from a live subject against a monochromatic background screen and capturing a background reference image from the monochromatic background.

The raw clip and background reference image are captured using cameras with a minimum resolution of 1280 pixels by 720 pixels. In a preferred embodiment, the raw clip and background reference image are captured digitally. In other embodiments, the raw clip and background reference image are captured using high definition video tape or high definition film. In these embodiments, the raw clip and background reference image are transferred to digital format.

In another embodiment, the method further includes the step of creating the keyed video clip and matte from a raw clip and background reference image using a chroma keying software application. In yet another embodiment, the invention includes the step of receiving a request to access the keyed video clip and matte.

In another embodiment, the keyed video clip and matte are stored in a lossless video codec format such as Animation codec. In yet another embodiment, the keyed video clip and matte are exported into a lossless image compression format such as targa (TGA) sequences.

The present invention further comprises the step of distributing the background reference image. In still another embodiment, the raw clip, keyed video clip, matte, and background reference image are distributed under a license agreement.

The present invention also discloses a method for distributing a pre-edited, keyed video clip and matte, the method comprising the steps of collecting the keyed video clip and matte, storing the keyed video clip and matte in an electronic repository, and distributing a raw clip, keyed video clip, and matte in a lossless image compression format over the Internet.

In one embodiment of the present invention, the method further comprises the step of editing the keyed video clip and matte to enhance quality and crispness of picture. In another embodiment, the keyed video clip and matte are solicited submissions from a third party contributor. In yet another embodiment, the invention includes the step of receiving a request to access the keyed video clip and matte.

In another embodiment, the keyed video clip and matte are exported into a lossless image compression format. Preferably, the files are exported into targa (TGA) sequences. In further embodiments, the files are stored and distributed using a lossless data compression format. In yet another embodiment, the raw clip, keyed video clip, and matte are distributed under license agreements.

The present invention represents a striking change to the current methods for producing and delivering video clips that have been processed using chroma key technology. Typically, a producer or editor will deliver a composite image, comprising a video clip with a replacement background image, based on a specific, intended use for the clip. A person who wants to integrate a video clip of a performer into his or her own background scenes, however, would have to arrange for the filming of the performer, editing of the film, and chroma-key post-production work to produce a keyed file of the performer without any background image.

In contrast, the present invention represents a means for mass producing and distributing stock video footage that can be easily downloaded over the Internet and licensed to many users. In the example above, for instance, the present invention allows a person to simply download a video clip of the performer that has already been edited and produced, and is in a form such that it can be easily incorporated into the end user's proprietary backgrounds or proprietary scenes.

### BRIEF DESCRIPTION OF THE DRAWINGS

FIG. 1 is a block diagram illustrating the storing, accessing, and distribution method of the present invention.

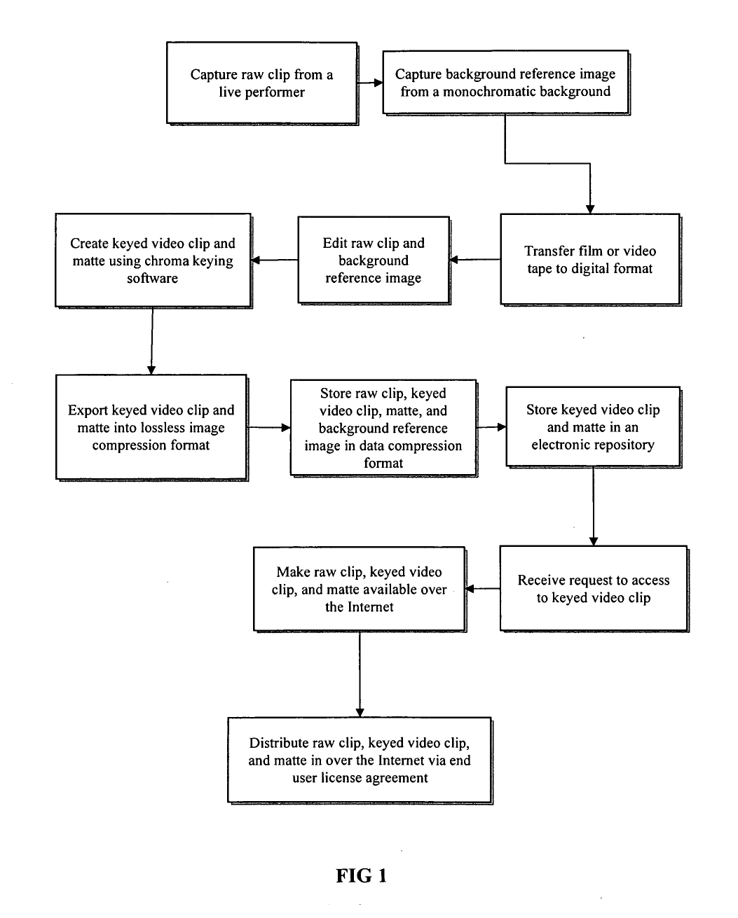

FIG. 2 is an illustration of the production system used to capture a performer and background screen.

FIG. 3 depicts a keyed video clip after the chroma keying process.

FIG. 4 depicts a matte after the chroma keying process.

### DETAILED DESCRIPTION OF THE INVENTION

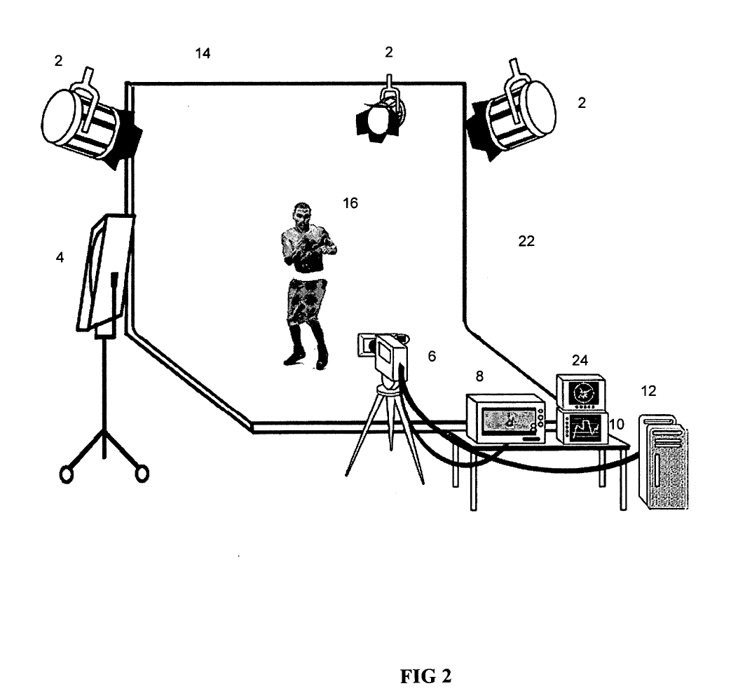

To produce an accurately keyed video clip using chroma key processing, it is imperative to use consistent conditions when capturing the raw clip and the background. The raw clip is the original video of the performer against a monochromatic background. The raw clip is captured using a professional production system as shown in FIG. 2. FIG. 2 represents a system of sophisticated cameras and lighting that is used to precisely capture the raw clip and background screen. The production system comprises lighting 2, at least one camera 6 positioned about the performer 16, and at least three multiple monitors that display information about the colors being captured in the raw clip. Lighting 2 may be positioned such that consistent lighting can be achieved both with and without the presence of the performer 16. Preferably, not less than two lights are used to illuminate the performer. At least one camera 6 may be positioned at any angle that is most appropriate to capture the performer's action. Preferably, one camera is used to capture the performer 16, however more than one camera may be used. Each camera is able to shoot in high-definition with a resolution of at least 1280×720 pixels.

Typically, the performer 16 will be captured in action. For example, the performer can be pitching a baseball, shaking hands, twirling an umbrella, or performing other acts. Further, more than one performer can be captured, such as two boxers fighting one another. To capture action with multiple performers, or to capture physical action where space is needed, for example to capture a person kicking a soccer ball, it is advantageous to capture the action in a large studio set 22. The production system of the present invention allows cameras to accurately capture complex action and action involving more than one person. A performer may also be captured while remaining still, for example, in a dance or yoga position. The performer 16 is preferably a human but can also be an animal or other object. The resulting video or film of the action serves as the raw clip during the chroma key processing stage.

The performer is captured in front of a monochromatic background 14 using the production system as shown in FIG. 2. The background 14 typically consists of a monochromatic screen or wall painted in a shade of green or blue. The background is painted with a paint specifically developed for chroma key processing. Colors other than blue and green, such as magenta, may be used for the background color but are less preferred.

At least three monitors are positioned near the camera 6 capturing the raw clip. The camera feed is split into three monitors: a color monitor 8, waveform monitor 10, and vectorscope 24. The monitors display information about the colors of the raw clip as it is being filmed and are consistently reviewed and during production. The color monitor 8 displays the raw clip being captured and is regulated by a white balance. The waveform monitor 10 displays the luminance, or the brightness of each color channel transmitted. Luminance levels must be at least 75% to prevent the green background from blending into any colors on the performer. When using a blue screen as a background, the luminance levels also must be maintained at 75%. The vectorscope 24 measures the chrominance of each color channel, or the saturation of the color signal. While capturing the raw clip, the luminance and chrominance levels are constantly monitored to verify color consistency.

During the chroma keying process, an image of the background without the performer serves as the key. To produce the key, or the background reference image, the background screen 14 is captured separately, without the performer, using the same production system as is used to capture the raw clip. In the present invention, the background 14 may be captured either before or after the raw clip has been captured. The background reference image should match as closely as possible to the background in the raw clip. In order to match the background reference image as closely as possible to the background in the raw clip, the lighting 2 used to capture the raw clip and the background screen should remain consistent. Preferably, the background 14 is captured either immediately before or immediately after the raw clip to reduce variances in lighting and other studio conditions. Any variation between the reference image and the background of the raw clip produces inaccurate results in the keying process. The production system is located in a studio such that the elements surrounding the filming, such as lighting, remain consistent.

The raw clip and background may be captured in multiple media forms, but digital media is preferred. Using digital media, the raw clip and background reference image are recorded directly onto a digital storage card or hard drive associated with the camera or cameras. Professional digital video storage, such as P2 cards developed by Panasonic, is preferably used to store the raw video footage. As technology progresses in the field of digital video storage devices, other storage devices may be used with the present invention. Using digital media, the filming is tapeless—there is no tape or film to further process. Instead, the images are directly stored into digital files and are immediately available for editing.

The images can also be captured using high definition film or high definition video tape. High definition film or video tape provides better stability than tapeless storage during the filming process because film and video tape provide a back up storage during the filming process. Capturing footage using film or video tape, however, increases post-production time because the film or tape has to be converted into digital format. The raw video footage, if shot on high definition film or video tape, is stored directly onto the tape or film in a compressed format. To convert the raw footage to digital footage, the film or tape must first be unspooled, or de-compressed. The de-compressed film is then converted into a digital format and compressed. Tapeless storage eliminates the additional de-compression and re-compression steps which can take approximately twelve hours to complete, depending on the size of the raw clip. By using cameras with digital storage, the raw clip and matte are immediately available for editing.

Once the high-definition raw clip and background reference image have been transferred to digital format, if necessary, they are edited using commercially available software. During the editing stage, the images are stored in a lossless video compression format, such as Animation coder-decoder (codec). Animation codec, produced by Apple Computer, Inc., is advantageous for video production due to its high resolution and ability to store metadata associated with the raw clip. Animation codec is also advantageous because it is lossless. A lossless file compression algorithm is one that compresses a file such that the original file, when compressed then decompressed, does not lose any characteristics of the original file. The decompressed file matches the original file bit by bit and maintains video quality, which is necessary when producing videos that need to contain sharp outlines. Animation codec also stores an alpha channel which specifies the transparency of a pixel's colors and how a pixel should be merged with another pixel when the two are overlaid on top of one another.

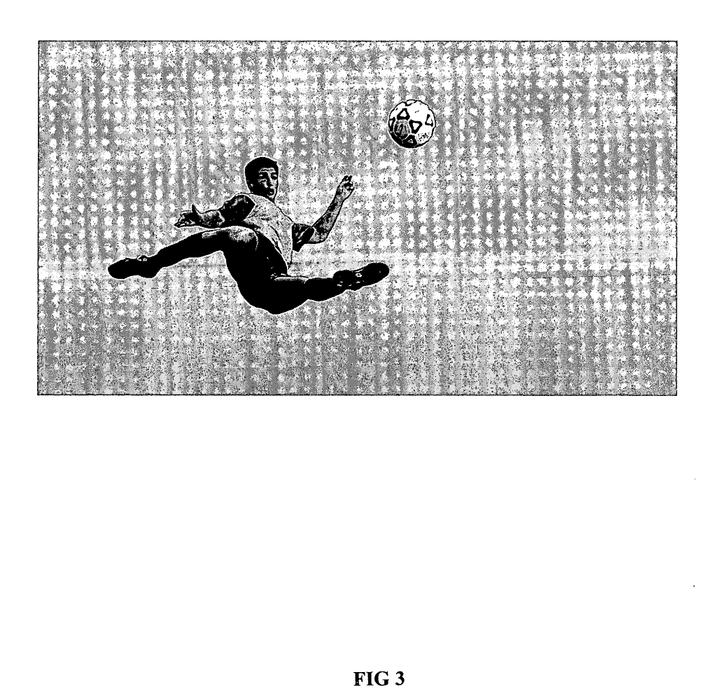

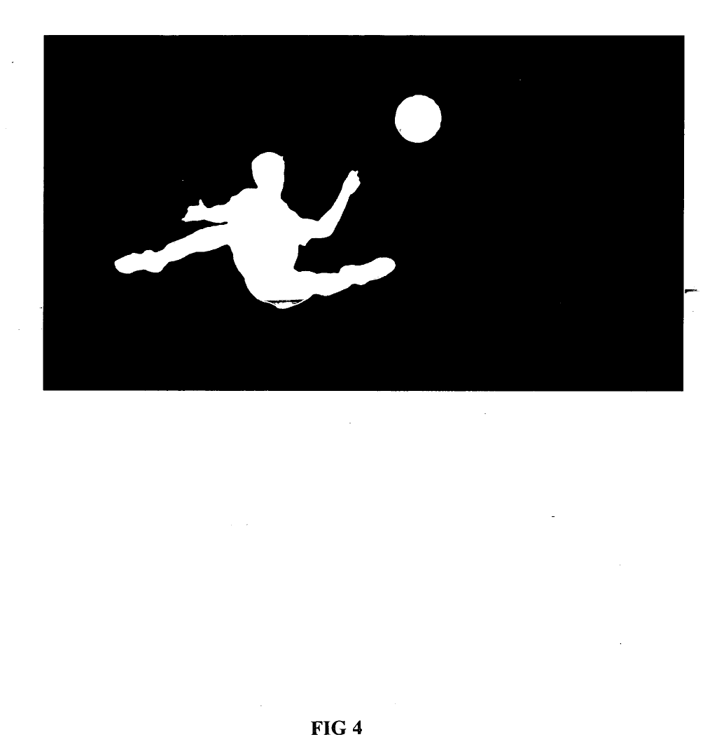

After the images have been edited, if necessary, the raw clip is ready to be keyed. Keying is the process of separating the performer from the background. The keying process can be performed using a commercially available software application and results in two files—the keyed file, or keyed video clip FIG. 3, and the “matte” or “alpha channel” file FIG. 4. The background reference image serves as a key against the raw clip. During the keying process, pixels of the background reference image are identified as background pixels. Corresponding background pixels in the raw clip are identified and removed to form a separate matte file. The matte file 20 consists of only the background pixels from the raw clip. The keyed video clip 18, in contrast has no background pixels. Once each background pixel is identified in the raw clip and removed to the matte file 20, the keyed video clip 18 contains only the performer in action.

The keyed video clip 18 is next further processed to eliminate any remaining background pixels, or spill. The keyed video clip is also preferably stored in a color difference component sampling scheme of 4:2:2 and at a frame frequency of 60 frames per second. Further, the keyed video clip is available at an aspect ratio of 16 parts wide by 9 parts high, an aspect ratio that is typical of high definition, widescreen video or film.

After final editing, the keyed video clip 18 and the corresponding matte 20 are exported into a lossless image compression format such as targa sequences (TGA). The raw clip and original background footage are also exported into a lossless file format such as TGA. The current industry standard is to make video clips available in Quicktime format, produced by Apple Computer, Inc. Using Quicktime format, however, prevents efficient file downloads over the Internet. If one bit is not transmitted correctly, the entire file becomes corrupt. A user may attempt many downloads before the file is transmitted correctly in a non-corrupt format. Using a lossless compression format, however, alleviates transmission failures. The keyed video clip is broken into many frames and if one frame is not downloaded correctly, the entire file is not corrupt. Instead, an internal algorithm reconstructs the file and downloading resumes at the last frame that was successfully downloaded. While lossless compressions formats such as TGA cannot compress files to sizes as small as that achieved by non lossless formats, or lossy format, the TGA format eliminates aborted downloads. Further, lossless compression files maintain superior video quality. The compressed image, bit-for-bit, remains a perfect match with the original file.

After exporting the raw clip, keyed video clip, matte, and background reference image into a lossless digital compression format, each file is further compressed into a lossless data compression format, such as a ZIP file format produced by WinZip Computing. After being compressed, each file: the keyed video clip, matte, raw clip, and reference background image, are stored by a unique identification number. The files are then uploaded onto a server that supports file transfer protocol (ftp). In the present invention, an end user, or potential licensee, requests access to a keyed video clip through the Internet or through other communication means. A potential licensee can request the keyed video clip by its catalog number, or by some other unique identifier. The potential licensee can search an electronic repository of video clips by category, such as sports, business, or lifestyle, or merely browse a web site that displays multiple web pages with links to the video clips.

A licensee requests access to a keyed video clip, and with that clip receives access to the matte and the raw clip associated with the video clip. Distributing the raw clip enables an end user to provide color saturation and greater image detail to images in the keyed clip. An end user incorporating the keyed video clip and matte also uses the raw clip to add sharpness to the outline of the performer. Distributing the matte allows an end user to precisely overlay the files onto the end user's proprietary background scenes. The layered files form a final, composite video clip containing the end user's replacement background, the keyed video clip, and the matte. After overlaying the files, the end user may desire sharper outlines of the live subject against the purchaser's replacement background. If so, the end user can use the color data contained in the raw clip to further edit the composite file.

In a preferred embodiment, the keyed video clip 18, matte 20, raw clip, and background reference image are made available under a license agreement. Preferably, the license agreement is based on usage of a single keyed video clip. The license agreements offered vary remarkably from the standard agreements provided in the industry and are more simple to administer. Currently in the industry, video clips are licensed based on four traditional factors: territory, frequency, duration, and media channels. Each license offered is limited specifically on the user's intended use in all four categories. For example, a license may define usage to be for North America, unlimited in frequency, for one year, and for television only.

In the present invention, the license agreements are not limited to each category and have much simpler terms. A licensee can choose from multiple license agreements, each license agreement varying the terms of use of the keyed video clip and associated files. The license agreement can take on multiple forms, such as an exclusive license agreement for all broadcast media. The license can also be a royalty-free, single-user, non-exclusive license for unlimited frequency, duration, and media type. A licensee can also purchase a non-exclusive, worldwide license for unlimited use in one type of media, such as only web or only broadcast media. Even further, a licensee can download a keyed video clip, matte, raw clip, and background reference image under a non-broadcast license for internal use only. In one embodiment, a potential licensee can download a trial version of a keyed video clip before agreeing to license the keyed video clip and associated files.

In another embodiment of the present invention, a keyed video clip, matte, raw clip, and background reference image are collected from a third party. A third party communicates by phone or other communication means that the third party would like to submit video clips to the electronic repository. The submitting party may already have produced and edited a keyed video clip and matte, or alternatively, the submitting party may ask what types of video clips are desired, such as lifestyle or particular sport clips, and offer to submit those clips. Keyed video clips that are submitted and not produced with a luminance level of at least 75% are rejected. If the clips have been produced using at least a 75% luminance level, the keyed video clip, matte, raw clip, and background reference image are submitted for review.

The submitting third party uploads the files onto a shared access server that supports the ftp protocol. The files may also be delivered by any other means, including electronically or on other storage devices. The files, however, are large in size even in a compressed format, so electronic file transfer is preferred. An editor then reviews the files for substantive content and quality of content, including but not limited to color intensity, luminance, and image clarity and crispness. If the files do not pass these quality control measures, the files are rejected and returned to the submitting third party. Alternatively, if the submitted files pass quality control standards, the files are accepted. An editor edits the files, if necessary, to correct any flaws in the images.

The keyed video clip, matte, raw clip, and background reference image are then exported into a lossless image compression format. Targa (TGA) is a preferred image compression format because TGA image sequences retain extra channels and metadata information. The files are then further compressed, preferably into a lossless data compression format such as ZIP, before being uploaded into the electronic repository. Similar to files that are produced in house, each submitted file is stored using a unique identifying number and uploaded into the repository and made available over the Internet.

The terms and expressions used in the foregoing section are used as terms of description and not limitation. It will be understood by those skilled in the art that various changes in form and detail may be made without departing from the scope of the invention.

We claim:

1. A method for distributing a pre-edited, keyed video clip and matte produced using chroma key processing, the method comprising the steps of:
(a) storing the keyed video clip and matte in an electronic repository and
(b) distributing a raw clip, the keyed video clip, and the matte in a lossless image compression format over the Internet.

2. The method of claim 1 further comprising the step of capturing the raw clip from a live subject and a monochromatic background.

3. The method of claim 2 further comprising the step of capturing a background reference image from the monochromatic background.

4. The method of claim 3 further comprising the use of at least one camera with a minimum resolution of 1280 pixels by 720 pixels for said capturing.

5. The method of claim 4 further comprising a camera using digital image storage.

6. The method of claim 4 further comprising a camera using high definition video tape.

7. The method of claim 6 further comprising the step of transferring the raw clip and background reference image to a digital format.

8. The method of claim 4 further comprising a camera using high definition film.

9. The method of claim 8 further comprising the step of transferring the raw clip and background reference to digital format.

10. The method of claim 3 further comprising the step of creating the keyed video clip and matte from the raw clip and background reference image using a chroma keying software application.

11. The method of claim 10 wherein the background reference image is captured immediately after the raw clip.

12. The method of claim 1 further comprising the step of receiving a request to access the keyed video clip and matte.

13. The method of claim 1 further comprising the step of storing the video clip and matte using a lossless video codec.

14. The method of claim 13 wherein the lossless video codec is Animation codec.

15. The method of claim 1 further comprising the step of exporting the keyed video clip and matte into a lossless image compression format.

16. The method of claim 15 wherein the lossless image compression format is targa (TGA) sequences.

17. The method of claim 1 further comprising the step of storing the keyed video clip and matte in a lossless data compression format.

18. The method of claim 1 further comprising the step of distributing the keyed video clip and matte as separate files.

19. The method of claim 1 further comprising the step of licensing the raw clip, keyed video clip, and matte.

20. The method of claim 3 further comprising the step of distributing the background reference image.

21. A method for distributing a pre-edited, keyed video clip and matte produced using chroma key processing, the method comprising the steps of:
(a) collecting a raw clip, keyed video clip, and matte;
(b) storing the keyed video clip and matte in an electronic repository; and
(c) distributing a raw clip, the keyed video clip, and the matte in a lossless image compression format over the Internet.

22. The method of claim 21 further comprising the step of editing the keyed video clip and matte.

23. The method of claim 21 further comprising the step of receiving a request to access the keyed video clip and matte.

24. The method of claim 21 further comprising the step of soliciting the raw clip, keyed video clip, and matte.

25. The method of claim 21 further comprising the step of exporting the keyed video clip and matte into a lossless image compression format.

26. The method of claim 25 wherein the lossless image compression format is targa (TGA) sequences.

27. The method of claim 21 further comprising the step of storing the keyed video clip and matte in a lossless data compression format.

28. The method of claim 21 further comprising the step of distributing the keyed video clip and matte as separate files.

29. The method of claim 21 further comprising the step of licensing the raw clip, keyed video clip, and matte.
